(19) United States
(12) Patent Application Publication
(10) Pub. No.: US 2009/0199771 A1
(43) Pub. Date: Aug. 13, 2009

(54) FEEDING APPARATUS

(76) Inventor: Kuo-Tang TSENG, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/425,999

(22) Filed: Apr. 17, 2009

Related U.S. Application Data
(62) Division of application No. 11/699,377, filed on Jan. 30, 2007.

(51) Int. Cl. A01K 61/02

(52) U.S. Cl. 119/51.04

(57) ABSTRACT

The present invention discloses a feeding apparatus connectable to several feeding ducts and includes a first turntable, a fixing plate and a second turntable under a storage bin. The bottom of the storage bin is fixed to the fixing plate, and has several discharge holes, and the first and second turntables can be rotated synchronously, and several outlet holes are built corresponding to the discharge holes. When the first and second turntable are rotated, the positions of the discharge holes and the outlet holes interlaced and superimposed intermittently, so that the feed stored in the storage bin can be dropped intermittently. With a feeding air current, the feed is delivered to the outside in a high speed from each feeding duct, such that each feeding duct can distribute the feed to several feeding points, and the feeding apparatus is particularly suitable for an aquatic farm with high-density breeding tanks.

### BACKGROUND OF THE INVENTION

1. Field of the Invention

The present invention relates to a feeding apparatus used for aquaculture, and more particularly to a feeding apparatus capable of feeding several different feeding points simultaneously and measuring the quantity of feed.

2. Description of the Related Art

In general, traditional feeding methods adopted by the aquaculture industry perform a feeding manually by distributing and applying the feed to different feeding points. Since the breeding technology advances rapidly in recent years, each aquatic farm usually employs a high-density breeding tank for aquaculture, in hope of saving manpower resources by automated management and improving the competitiveness of the aquaculture industry.

Theoretically, if several breeding tanks are used simultaneously for breeding the same species of aquatic product and the conditions such as water quality, temperature and feeding quantity are the same, then the growing conditions of an aquatic product in each breeding tank and the harvest timing should be the same.

Therefore, the inventor of the present invention intends to design a feeding apparatus in compliance with the automated breeding and distribute the same quantity of feed to several breeding tanks simultaneously.

### SUMMARY OF THE INVENTION

In view of the foregoing shortcomings of the prior art, the inventor of the present invention based on years of experience in the related field to conduct extensive researches and experiments, and final developed a feeding apparatus in accordance with the present invention.

Therefore, it is a primary objective of the present invention to provide a feeding apparatus comprising a first turntable, a fixing plate, and a second turntable under a storage bin, wherein the bottom of the storage bin is fixed to the fixing plate, and a plurality of discharge holes are disposed at the bottom of the storage bin, and the first and second turntables can be rotated synchronously, and a plurality of outlet holes are built corresponding to the discharge holes. When the first and second turntables are rotated, the feed stored in the storage bin can be dropped intermittently by interlacing and superimposing the positions of the discharge holes and outlet holes intermittently. With a feeding air current, the feed is delivered in a high speed through each feeding duct, so that the feeding ducts can distribute the feed to several feeding points, so as to achieve the effects of distributing and feeding the same quantity of feed to several breeding tanks or several feeding points simultaneously.

In a preferred embodiment of the present invention, each feeding duct can be rotated or fixed to a fixed position for the feeding, and the first and second preferred embodiments of the present invention are described as follows:

In the first preferred embodiment, each feeding duct is rotated for the feeding, and each outlet hole of the second turntable includes a feeding duct disposed at the bottom of each outlet hole, and the center position of the storage bin has a fixed axle penetrating from top to bottom through the first turntable, the fixing plate, and the second turntable.

The fixed axle includes a center hole along its axial direction, and the center hole is sealed at a depth corresponding to the height of the second turntable, and the fixed axle includes a plurality of axial through holes interconnected with the center hole and disposed at an external edge of the fixed axle and at a position equal to the height of the second turntable, so that after the high-speed airflow enters from the top of the center hole, the airflow flows into the through hole.

A plurality of radial air holes are disposed at the center of the second turntable and at a position connected with the fixed axle and between each outlet hole and each through hole of the fixed axle, such that the outlet holes and the through holes are interconnected by the connection of the air holes.

After the high-speed airflow enters into the fixed axle through the center hole, the airflow is passed through the through holes and the air holes sequentially, and blown out from the outlet holes of the second turntable, and the feed in the outlet holes is blown to the feeding ducts, and delivered to the feeding points through the feeding ducts.

Since each feeding duct is fixed to the bottom of each outlet hole of the second turntable, therefore each feeding duct is moved accordingly when the second turntable is rotated, so as to achieve the purposes of performing the feeding by a rotation method and improving the efficiency of the feeding operation.

In the second preferred embodiment of the present invention, each feeding duct is fixed to a position for the feeding, and the second turntable includes a fixed base and an air supply base under the second turntable, wherein the base has a plurality of penetrating holes corresponding to the outlet holes of the second turntable, and each penetrating hole is connected to a feeding duct, and the periphery of the base has a surrounding ventilating channel interconnected with each penetrating hole.

The air supply base is disposed at the periphery of the base for sealing the ventilating channel, and the air supply base includes an air supply hole corresponding to the ventilating channel for inputting high-pressure air, such that the high-pressure air is entered from the air supply hole and the ventilating channel into each penetrating hole to produce a feeding air current.

If the feed in the storage bin is rotated by the first and second turntables and dropped into the outlet holes of the second turntable, and the second turntable is rotated continuously until the outlet holes and the penetrating holes are superimposed with each other, the air supply base will input the feeding air current of the base ventilating channel to deliver the feed dropped from the outlet holed into the penetrating hole to the feeding ducts, and then the feed will be delivered to fixed locations by the extension of the feeding ducts.

### BRIEF DESCRIPTION OF THE DRAWINGS

FIG. 1 is a schematic view of a structure in accordance with a first preferred embodiment of the present invention;

FIG. 2 is a schematic view of interlacing each outlet hole and each discharge hole in accordance with a first preferred embodiment of the present invention;

FIG. 2A is another schematic view of interlacing each outlet hole and each discharge hole in accordance with a first preferred embodiment of the present invention;

FIG. 3 is a schematic view of superimposing each outlet hole and each discharge hole in accordance with a first preferred embodiment of the present invention;

FIG. 4 is a schematic view of a structure with a transmission method in accordance with a first preferred embodiment of the present invention; and

FIG. 5 is a schematic view of a structure in accordance with a second preferred embodiment of the present invention.

### DETAILED DESCRIPTION OF THE PREFERRED EMBODIMENTS

The above and other objects, features and advantages of the present invention will become apparent in the following detailed description of the preferred embodiments with reference to the accompanying drawing.

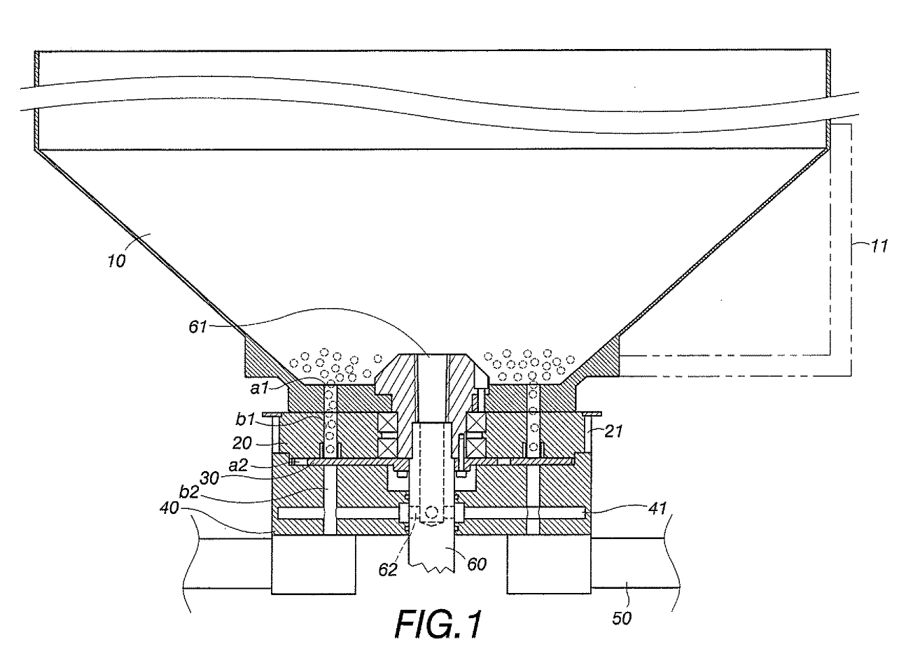

Referring to FIG. 1 for a feeding apparatus of a first preferred embodiment of the present invention, the feeding apparatus comprises a first turntable 20, a fixing plate 30 and a second turntable 40 disposed under a storage bin 10.

The storage bin 10 in a cylindrical shape is fixed at a position for containing the feed, and the bottom of the storage bin 10 has a plurality of discharge holes a1 penetrating from top to bottom. In this embodiment, a fixed portion 11 is disposed on a lateral side of the storage bin 10 for hanging and fixing the storage bin 10.

The first turntable 20 is disposed under the storage bin 10 and has a plurality of outlet holes b1 corresponding to the discharge holes a1 of the storage bin 10 respectively, and the first turntable 20 can be rotated with respect to the storage bin 10. During the rotation, the outlet holes b1 are interlaced or superimposed intermittently with the discharge holes a1 of the storage bin 10. If the outlet holes b1 are superimposed with the discharge holes a1, the feed in the storage bin 10 will be dropped from the discharge holes a1 into the outlet holes b1.

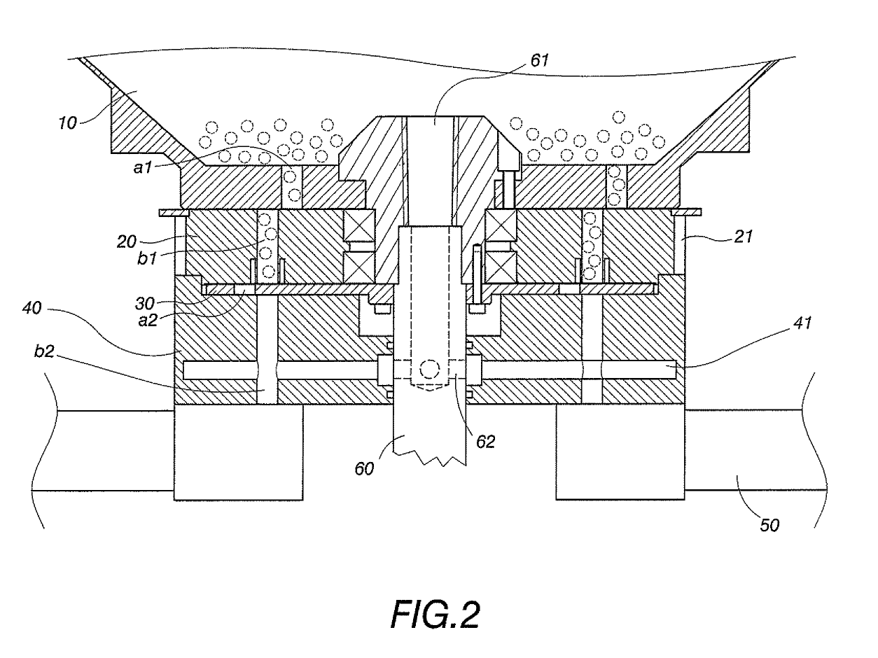

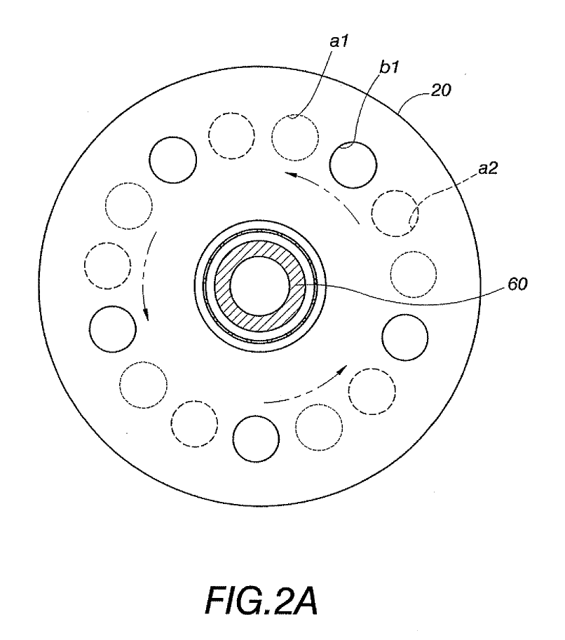

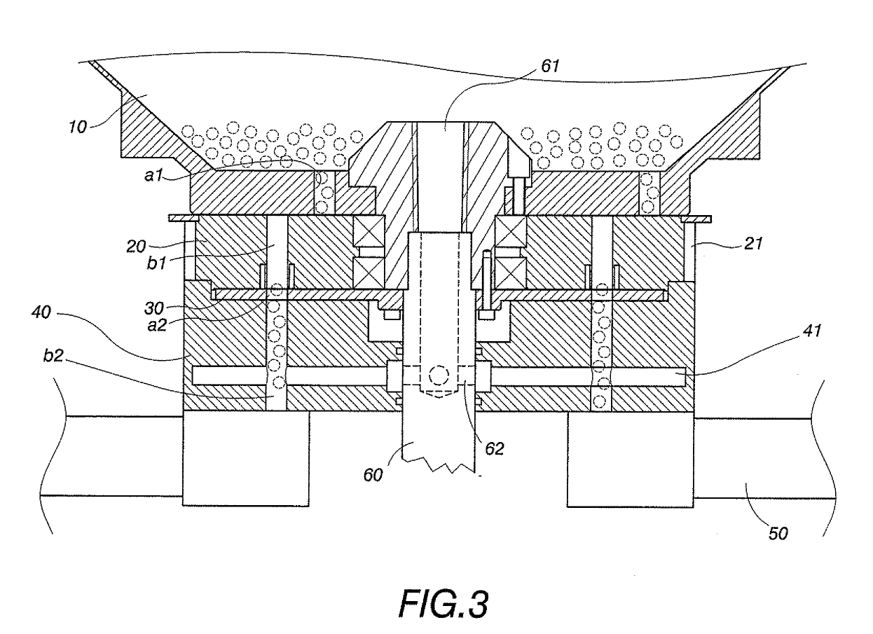

Referring to FIGS. 2 and 3, cross-sectional views of the first turntable 20 and the second turntable 40 in a rotation status are used for illustrations, and the fixing plate 30 is installed under the first turntable 20 and in a fixed status together with the storage bin 10. The fixing plate 30 also includes a plurality of discharge holes a2, and the positions of the discharge holes a2 on the fixing plate 30 are interlaced with the positions of the discharge holes a1 on the storage bin 10. In other words, when the feed in the storage bin 10 is dropped from the discharge holes a1 into the outlet holes b1, the positions of the discharge holes b2 on the fixing plate 30 are interlaced with the positions of the outlet holes b1 (also see FIG. 2A), such that the feed temporarily remains in the outlet holes b1 of the first turntable 20, until the first turntable 20 continues to rotate to superimpose the outlet holes b1 with the discharge holes a2 on the fixing plate 30, so that the feed will be dropped through the discharge holes a2 of the fixing plate 30.

The second turntable 40 is installed under the fixing plate 30 and rotated with the first turntable 20 synchronously, and the second turntable 40 includes a plurality of outlet holes b2 corresponding to the discharge holes a2 of the fixing plate 30, and the positions of the outlet holes b2 of the second turntable 40 are the same as the positions of the outlet holes b1 of the first turntable 20. If the first and second turntables 20, 40 are rotated synchronously, the outlet holes b1, b2 of the first and second turntable 20, 40 will be superimposed with the discharge holes a2 of the fixing plate 30 simultaneously, and the feed passing through the discharge holes a2 of the fixing plate 30 will be dropped into the outlet hole b2 of the second turntable 40 and discharged to the outside through the outlet holes b2.

In this embodiment, a feeding duct 50 is installed to the bottom of each outlet hole b2 of the second turntable 40, and a fixed axle 60 is installed at the center position of the storage bin 10 and penetrates through the first turntable 20, the fixing plate 30 and the second turntable 40 sequentially from top to bottom, and the fixed axle 60 is fixed to the storage bin 10 and the fixing plate 30, so that the first turntable 20 and the second turntable 40 can be rotated with respect to the fixed axle 60.

The fixed axle 60 has a center hole 61 disposed in its axial direction, and the top of the center hole 61 is provided for inputting a high-speed airflow and sealed at a depth equal to the height of the second turntable 40, and a plurality of radial through holes 62 interconnected with the center hole 61 and disposed on an external edge of the fixed axle 60 and at a position equal to the height of the second turntable 40, such that after the high-speed airflow enters from the top of the center hole 61, the airflow is passed laterally to the through holes 62.

A plurality of radial air holes 41 are disposed at positions where the center of the second turntable 40 is connected with the fixed axle 60 and between each outlet hole b2 and each through hole 62 of the fixed axle 60, so that the outlet holes b2 and the through holes 62 are interconnected through the connection of the air holes 41.

After the high-speed airflow is entered from the center hole 61 into fixed axle 60 and passed through the through holes 62 and the air holes 41, the airflow is blown out from the outlet holes b2 of the second turntable 40, and the feed in the outlet holes b2 is delivered to the feeding ducts 50 and finally to the feeding points through the feeding ducts 50.

Since each feeding duct 50 is fixed to the bottom of each outlet hole b2 of the second turntable 40, therefore each feeding duct 50 can be moved accordingly when the second turntable 40 is rotated, so as to achieve the feeding purpose by a rotation method and improve the efficiency of the feeding operation.

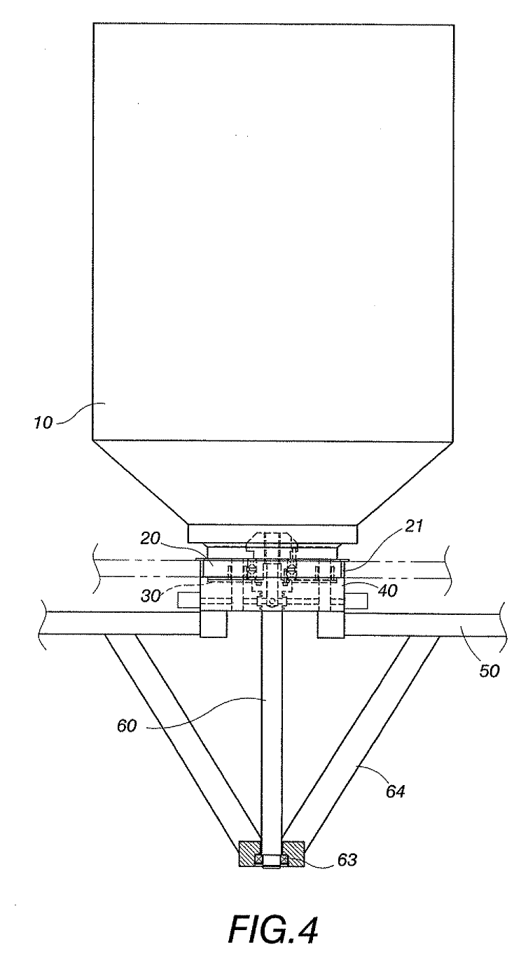

Referring to FIG. 4 for the first and second turntables 20, 40 of this embodiment, a groove 21 is disposed around the periphery of the first turntable 20 for embedding a timing belt for the transmission purpose, and the motor drives the timing belt to rotate the first and second turntables 20, 40 synchronously. The timing belt and motor are prior arts and thus will not be described here.

In FIG. 4, this preferred embodiment also discloses a method of using a plurality of feeding ducts 50 for the construction in addition to the transmission method. Since each feeding duct 50 is rotated at the second turntable 40 synchronously, therefore a bearing 63 can be installed and extended downward from the fixed axle 60 to provide a good support for the feeding ducts 50, and a plurality of support rods 64 with same number of feeding ducts 50 are installed around the bearing 63, so that each support rod 64 supports each feeding duct 50 to enhance the strength of the feeding duct 50. Since the bearing 63 is a rotating component, the feeding ducts 50 and support rods 64 can be driven to rotate the bearing 63 with respect to the fixed axle 60 when the first and second turntables 40 are rotated.

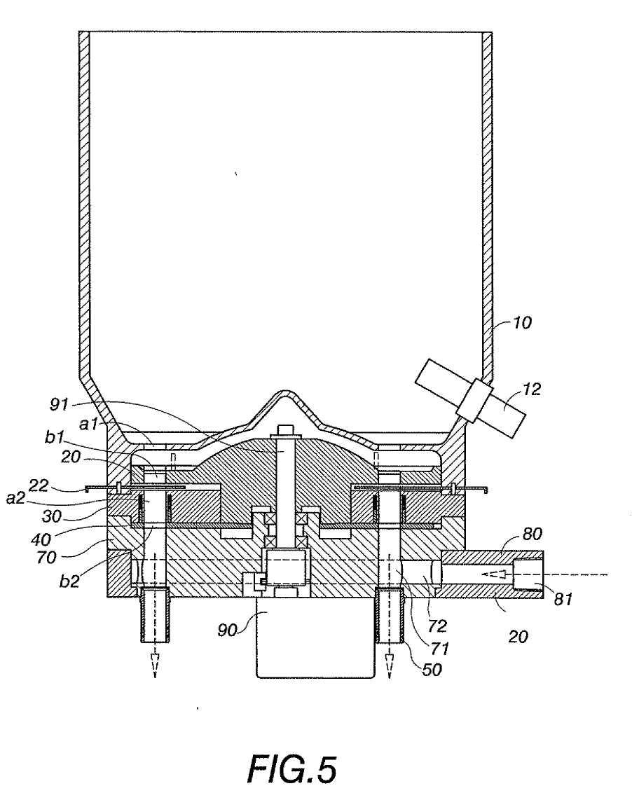

Referring to FIG. 5 for a second preferred embodiment of the present invention, the movement relations among the storage bin 10, the first turntable 20, the fixing plate 30, and the second turntable 40 are substantially the same as those of the previous embodiment, and thus will not be described further here, and the only differences are given below.

In FIG. 5, a fixed base 70 and an air supply base 80 are disposed under the second turntable 40, wherein a plurality of penetrating holes 71 corresponding to the outlet holes b2 of the second turntable 40 are disposed on the base 70 and penetrate from top to bottom, and a feeding duct 50 is connected to the bottom of each penetrating hole 71, so that each feeding duct 50 is fixed. In addition, a ventilating channel 72 is disposed around the periphery of the base 70 and interconnected with each penetrating hole 71.

The air supply base 80 is disposed at the periphery of the base 70 for sealing the ventilating channel, and the air supply base 80 includes an air supply hole 81 corresponding to the ventilating channel 72 for inputting high-pressure air, so that the high-pressure air enters from the air supply hole 81 and the ventilating channel 72 into each penetrating hole 71 to produce a feeding air current.

After the first and second turntables 20, 40 are rotated synchronously to deliver the feed in the storage bin 10 from the bottom of the discharge hole a1 through the outlet holes b1 of the first turntable 20, the discharge holes a2 of the fixing plate 30, and the outlet holes b2 of the second turntable 40 sequentially, and the second turntable 40 continues to rotate until the outlet hole b2 is superimposed with the penetrating hole 71, the feed in the outlet hole b2 will be dropped into the penetrating hole 71.

Now, the high-speed feeding air current is inputted from the air supply hole 81 of the air supply base 80 to the ventilating channel 72 of the base 70, so that the feed in the penetrating hole 71 can be delivered to the feeding ducts 50 and finally to fixed locations by the extension of the feeding ducts 50.

Since a base 70 and an air supply base 80 in a fixed status are installed at the bottom of the second turntable 40, therefore a motor 90 can be installed under the base 70 for the transmission purpose, and a transmission shaft 91 of the motor is extended upward and passed through the base 70, the second turntable 40, the fixing plate 30 and the first turntable 20, and fixed with the first and second turntables 20, 40, such that when the transmission shaft 91 of the motor 90 is rotated, the first and second turntables 20, 40 can be rotated synchronously.

In this embodiment, a no-feed sensor 12 is installed at the bottom of the storage bin 10 for detecting whether or not the feed contained in the storage bin 10 is exhausted. The first turntable 20 includes a manual gate 22 corresponding to a lateral side of each outlet hole b1 for opening or closing the outlet hole b1, so that the feed can be controlled to be delivered through each outlet hole b1 for a feeding control purpose.

Only some embodiments of the present invention have been illustrated in the drawings, but it should be pointed out that many other modifications are conceivable within the scope of the following claims.

What is claimed is:

1. A feeding apparatus, comprising:
a storage bin, for containing a feed, and having a plurality of discharge holes disposed at the bottom of said storage bin and penetrating from top to bottom;
a first turntable, rotated with respect to said storage bin, and disposed under said storage bin, and having a plurality of outlet holes corresponding to said discharge holes of said storage bin, such that when said first turntable is rotated, said outlet holes and said discharge holes of said storage bin are interlaced or superimposed intermittently, and when said outlet holes are superimposed with said discharge holes, said feed in said storage bin will be dropped from said discharge holes into said outlet holes;
a fixing plate, installed under said first turntable, and fixed with said storage bin, and said fixing plate includes a plurality of discharge holes thereon, and the positions of said discharge holes of said fixing plate are interlaced with the positions of said discharge holes of said storage bin, such that when said feed in said storage bin is dropped into said outlet holes of said first turntable, the positions of said discharge holes of said fixing plate are interlaced with the positions of said outlet holes, so that said feed remains in said outlet holes of said first turntable temporarily; and
a second turntable, installed under said fixing plate, and rotated with said first turntable synchronously, and including a plurality of outlet holes corresponding to said discharge holes of said fixing plate, and the positions of said outlet holes of said second turntable are the same as the positions of said outlet holes of said first turntable respectively, such that when said first and second turntables are rotated synchronously, said outlet holes of said first and second turntables are superimposed with said discharge holes of said fixing plate respectively, and said feed is dropped from said discharge holes of said fixing plate into said outlet holes of said second turntable, and then to the outside through said outlet holes,
wherein said second turntable includes a fixed base and an air supply base disposed under said second turntable, and said base includes a plurality of penetrating holes corresponding to said outlet hole of said second turntable and penetrating from top to bottom, and said each penetrating hole is connected to a feeding duct, and said base includes a surrounding ventilating channel connected with said each penetrating hole, and an air supply base is disposed at the periphery of said base for sealing said ventilating channel, and said air supply base comprises an air supply hole corresponding to said ventilating channel for inputting high-pressure air, such that said high-pressure air enters from said air supply hole and said ventilating channel into said each penetrating hole to produce a feeding air current, and said feed in said outlet holes is delivered to said feeding ducts through said penetrating hole, and said feed is delivered to said feeding points through said feeding ducts.

2. The feeding apparatus of claim 1, wherein said base includes a motor disposed under said base, and a transmission shaft of said motor is passed through said base, and said second turntable, said fixing plate and said first turntable are fixed with said first and second turntables, such that when said transmission shaft of said motor is rotated, said first and second turntables are driven to rotate synchronously.

3. The feeding apparatus of claim 1, wherein said storage bin includes a no-feed sensor installed at the bottom of said storage bin.

4. The feeding apparatus of claim 1, wherein said first turntable includes a manual gate installed on a lateral edge corresponding to said each outlet hole for opening or closing said each outlet hole.
